(19) United States
(12) Patent Application Publication
(10) Pub. No.: US 2007/0049693 A1
(43) Pub. Date: Mar. 1, 2007

(54) Flow enhancement compositions for liquid and gases in tubes and pipes

(75) Inventors: C. Edward Baxter JR., League City, TX (US); Mark K. Lay, Houston, TX (US)

Correspondence Address: BRACEWELL & GIULIANI LLP, P.O. BOX 61389, HOUSTON, TX, 77208-1389, US

(73) Assignee: EnviroFuels, LLC, Houston, TX (US)

(21) Appl. No.: 11/507,851

(22) Filed: Aug. 22, 2006

Related U.S. Application Data
(60) Provisional application No. 60/710,087, filed on Aug. 22, 2005.

(51) Int. Cl. C08L 35/02

(52) U.S. Cl. 525/225

(57) ABSTRACT

The present invention includes a flow enhancement composition and a method for enhancing flow using the flow enhancement composition in relation to liquid and gaseous flow in pipes, tubes, conduits and other transfer or transmission devices, particularly metallic.

### TECHNICAL FIELD OF THE INVENTION

The present invention relates to the field of flow enhancement compositions for liquid and gases moving in tubes and pipes, in particular, to an additive that decreases the amount of energy required to move the liquids and gases, and/or prevents the inefficient transfer of energy as the liquid and gases move through the tubes and pipes.

### BACKGROUND OF THE INVENTION

Liquids and gases have long been moved through tubes, pipes, conduits and other devices for various reasons including but not limited to mass transmission from one location to another, transfer of power from one location to another and transfer of energy from one location to another.

Mass transmission can be represented by the movement of oil and gas in transmission pipelines in which crude product is moved from, for example, from collection tanks and other storage areas in the field to the refineries for processing into various useable products and then the subsequent movement of these products to end use locations.

Power transfer is exemplified by closed hydraulic systems in which a non-compressible fluid is used to transfer power, usually with a mechanical advantage, to do work. Common examples are braking devices and power steering systems in on-road and off road vehicles, various aircraft systems, lifting devices, such as jacks and cranes, and any application in which a mechanical advantage can be realized by fluid movement.

This invention is also applicable to gases in power and energy transfer applications and can include, but not limited to, gas compressors and compression systems. Compressors can include rotary screw and reciprocating piston types.

This invention is also applicable to aqueous systems in metal pipes used for any of the above purposes and applications.

Chemical compounds have been used as flow improvers for a long time, mainly through the mechanism of drag reduction. Drag reducers—also known as Drag Reducing Agents, DRAs and Flow Improvers—are any material that reduces frictional pressure during fluid flow in a conduit or pipeline. Using DRAs allows increased flow using the same amount of energy or decreased pressure drop for the same flow rate of fluid in pipelines. These compounds are usually very high molecular weight hydrocarbon polymers and reduce drag by prevention of turbulent flow along the pipe walls.

High molecular weight aqueous soluble polymers are also known for reduction of drag in water systems.

These polymeric DRAs suffer from key disadvantages. Firstly, they are very shear unstable; that is the long polymer chains breakdown and become ineffective when exposed to even modest amounts of shear, even such as that generated by the pumps and other mechanical devices required to move the fluids. Polymeric DRAs also are not effective in regimes where the energy loss is not related to turbulent drag or in low Reynolds Number flow systems.

Other chemical compounds have been used for the reduction of energy loss, especially in refrigeration systems. These compounds are termed Polarized Refrigerant Oil Additives (PROA) and function by forming a microscopic layer on the inner surface of metal refrigeration tubes.

There are two major compounds in a cooling system; the oil used to lubricate the moving parts of the compressor and the refrigerant. In theory the oil remains in the compressor but, practically, some oil often leaks into the refrigerant side and forms a mixture that circulates inside the refrigeration tubes. As the mixture comes in contact with the metallic surfaces inside the tubes, the oil separates and builds up on the surface. The effect of this buildup is that the oil tends to act as a layer of insulation reducing the heat transfer efficiency. It also disrupts the flow of the refrigerant in the tubes further reducing cooling efficiency. PROAs typically have a polar group on one end of the molecule. This polar group has a higher affinity for the metal surface and displaces the oil layer and forms a monolayer on the surface thus increasing heat transfer and improving the flow efficiency in the tubes.

PROAs are generally halogenated, usually chlorinated, paraffins. These compounds are extremely hydrolytically unstable and can form corrosive acidic chlorine byproducts. These acidic by-products can cause extreme corrosion, not only inside the tubes but, also inside the compressor itself which is even more likely to be exposed to hydrolytic conditions.

A flow enhancement composition that can function to decrease the amount of energy required to move the liquids and gases through the tubes and pipes and prevents the inefficient transfer of energy as the liquid and gases move through the tubes and pipes would be advantageous. An additive that can function in all flow regimes would be particularly advantageous.

### SUMMARY OF THE INVENTION

The present invention includes a flow enhancement composition, a method of creating the flow enhancement composition and a method of enhancing flow in relation to liquid and gaseous jointly “fluid”) flow in pipes, tubes, conduits and other transfer or transmission devices, particularly metallic.

The flow enhancement composition of the invention includes the creation of a phosphorus-containing parent solution containing [Y]ₓH₂PO₄, and [Y]_{X+1}HPO₄, where Y is a cation. Y does not have to be the same cation in both salt compounds. The cationic portion of the salt components can be any cation, with potassium being a preferred cation. In a preferred embodiment, the components are KH₂PO₄, K₂HPO₄. These salts are at least partially dispersed in water or other appropriate solvent to create the phosphorus-containing parent solution. One preferred embodiment includes adding these component, in the presence of water, to create the phosphorus-containing parent solution as an aqueous parent solution. The water acts as the solvent. Other preferred parent solution solvents include alcohols. Another group of preferred cations would be the alkali metals or Group 1A elements. A particularly preferred cation includes boron. NH₄ can be used as the cation Y to create the flow enhancement composition that enhances flow performance. In certain instances, it is preferable to ammonium and thereby ammonia altogether.

In a preferred embodiment, the process for enhancement of flow of target fluid in a fluid system includes adding an effective amount of the flow enhancement composition to the target fluid for circulation in the fluid system, the fluid enhancement composition comprising a mixture of salts and a target fluid, the salts comprising [Y]ₓH₂PO₄ and [Y]ₓ₊₁HPO₄, where [Y] is a cation and x is an integer, such that the target fluid with the salts is operable to create enhance flow or enhanced transfer rate in the target fluid. In a preferred embodiment, the salts are non acidic. In a preferred embodiment, [Y] includes a Group I cation. Particularly preferred cations include sodium and potassium. A preferred embodiment includes the fluid enhancement composition and target fluid having substantially no free ammonia, halogens or added polymers. Another preferred embodiment includes as part of the flow enhancement composition the additional compound of [NH₄]₂HPO₄. Yet another preferred embodiment additionally includes NH₄C₂H₃O₂, where C₂H₃O₂ is an acetate group, in the flow enhancement composition.

The invention includes the process of enhancing fluid flow when the target fluid is a lubricant for circulation within a lubricant-dependant system. Examples of such lubricant-dependant systems include a mechanical device, a refrigeration system, a motor oil system, an engine, an engine part, a gear, a drilling operation and a reciprocating combustion engine

The invention includes the process of enhancing fluid flow when the target fluid is a heat transfer fluid for circulation within a heat transfer system. Examples of such heat transfer systems include a coolant system, a hydraulic braking system, a hydraulic transmission system, a refrigeration system and an air-conditioning system.

The invention includes the process of enhancing fluid flow when the target fluid is a hydro-mechanical fluid for inclusion in a mechanical system. Examples of such hydro-mechanical fluids include radiator fluid, drilling fluid, engine fluid, anti-corrosive fluid, transmission fluid, hydraulic fluid, brake fluid, dielectric fluid, heat transfer fluid and cutting fluid.

In another embodiment of the invention, the flow enhancement composition added to the target fluid for circulation in the fluid system includes a salt of the composition [Y]ₐB_{b}O_{c}, wherein [Y] is a cation and a, b and c are variable integers, such that the target fluid with the salt is operable to create enhance flow or enhanced transfer rate in the target fluid.

The phosphorus-containing parent solution is added or mixed with a dispersion fluid. The dispersion fluid is a fluid that is operable to maintain the salts within the dispersion fluid in at least a partially dispersed state and that is miscible, or capable of being maintained in solution, in fluid or gas contained in the flow system, jointly, the target fluid. In a preferred embodiment, the solvent is largely removed from the phosphorus-containing parent solution in the dispersion fluid through thermal means to create the flow enhancement composition. The flow enhancement composition is operable to increase the energy efficiency of the flowing system when placed into contact with fluid or gas contained in the system. Increased energy efficiency means less energy is required to operate the flow system when compared to operation without the flow enhancement composition.

Another preferred embodiment of the phosphorus-containing parent solution includes the addition of [NH₄]₂HPO₄ to the [Y]ₓH₂PO₄, [Y]ₓ₊₁HPO₄, and water or other solvent. Yet another embodiment includes the addition of NH₄C₂H₃O₂ where C₂H₃O₂⁻ion is an acetate group such that the solution contains [Y]ₓH₂PO₄, [Y]ₓ₊₁HPO₄, [NH₄]₂HPO₄, NH₄C2H3O2 and water. When the flow enhancement composition is prepared using ammonium compounds, ammonium compounds being defined as those compounds containing NHₓ groups, the nitrogen in the solution is essentially all in the form of ammonium ions. There is at most a negligible amount of free ammonia. In a preferred embodiment, the solution has a pH between about 6.0 and 8.0. In a preferred embodiment, there is an absence of added halogens. Also, in a preferred embodiment, there is an absence of polymers.

Another preferred embodiment of the phosphorus-containing parent solution includes the addition of [Y]ₓPO₄ to the [Y]ₓH₂PO₄, and [Y]ₓ₊₁HPO₄.

While orthophosphoric acids have been described, also called phosphoric acids, this includes pyrophosphoric acids, which are the condensed analogs of orthophosphoric acid. The difference being that, through the process to condense the orthophosphoric acid, the PO₄³⁻ becomes P₂O₇²⁻ or other condensed phosphates. Therefore, [Y]ₓH₂PO₄, and [Y]ₓ₊₁HPO₄ are precursors to pyrophosphoric acids. The use of the pyrophosphoric and other condensed forms is therefore encompassed within the definition of the orthophosphate form.

In a preferred embodiment, the invention encompasses a process for enhancement of flow of a target fluid in a fluid system comprising adding an effective amount of a flow enhancement composition to the target fluid for circulation in the fluid system. The fluid enhancement composition includes the mixture of salts [Y]ₓH₂PO₄ and [Y]ₓ₊₁HPO₄, where [Y] is a cation and x is an integer, and a target fluid such that the target fluid with the salts is operable to create

The phosphorus-containing parent solution of one embodiment of the invention can be used in any type of environment, either hydrophilic or hydrophobic environments. In the case of a hydrophobic environment, it may be necessary that a carrier fluid or fluids be selected to allow for proper dispersion. A dispersant used in conjunction with the carrier fluids to create the flow enhancement composition is also encompassed in a preferred embodiment. For non-aqueous flow applications, both liquid and gaseous at least one carrier fluid can preferably be a fluid with a least some hydrophilic character that is miscible with the flow system component(s) to act as compatibilizing agent in conjunction with dispersant.

The flow enhancement composition of the invention is useful to enhance the flow of liquid and gases in tubes and pipes such that less energy is required to cause the flow system to operate and/or less energy is lost during the operation of the flow system as compared to operation of the flow system without the additive.

The flow enhancement composition is used by adding this additive to the liquid or gaseous component(s) of the flow system in an amount sufficient to increase flow efficiency. The terms enhanced flow or increased flow efficiency refer to the reduction of energy necessary to operate the flow system or reduction of loss of energy during the operation of the flow system or a combination of both. A preferred embodiment includes the addition of between about 50 and 150 ppm phosphorus into the liquid or gaseous flow component(s) though the addition of the flow enhancement composition. Increased amounts of phosphorus are effective as well. It is notable that a very cost-effective solution can be prepared with low weight percent of phosphorus. Another preferred target is around 1 ppm phosphorus to 150 ppm phosphorus. Targets as low as 0.25 ppm phosphorus are also applicable.

Included in the invention is a process for enhancing flow performance of a liquid or gas in a flow system including the steps of providing the flow enhancement composition described above in an amount effective to enhance flow performance so as to reduce overall energy requirement by operating the flow system with the flow enhancement composition. The flow system can be any known to those with ordinary skill in the art of fluid flow. The term fluid flow is used in its broadest sense and can include, for example, liquid and gases. Flow systems can include any system in which the liquid or gas is in contact with a conduit, preferably metallic, in which the action of the flow enhancement composition can reduce the overall energy requirement or loss. In a preferred embodiment, this process is used with either a liquid or gaseous component(s). The result of adding the additive is an enhanced flow system. Preferably, the enhanced flow system contains phosphorus in an amount operable to reduce the amount of energy required to operate the system or to reduce the energy loss from the operation of the system compared to the flow system operation without the flow enhancement composition. More preferably, the component(s) of the flow system contain phosphorus of between about 1 and 150 ppm by weight.

An alternate embodiment of the invention includes a process for enhancing flow performance of a liquid or gas in a flow system including the steps of adding a chemical addition composition to the flowing component(s) in an amount effective to enhance flow performance. The chemical addition compositions is created by creating an intermediate solution by (i) mixing in an aqueous medium a source of reactive NH₂ groups with one of the following:
1. (a) an alkali metal hydroxide to raise the pH of the intermediate solution above 12 to form an aqueous ammonium/alkali metal hydroxide; or
2. (b) a source of phosphoric acid to lower the pH of the intermediate solution to about 0 to form an acidic ammonium mixture.
3. The next step includes either combining the intermediate solution of step (i.a.) with the source of phosphoric acid; or the intermediate solution of (i.b.) with the hydroxide at a rate sufficient to create a highly exothermic reaction. This results in reactive NH₂ groups being contained in solution during the formation of the chemical addition compositions. This chemical addition composition is added to the flow component(s).

The parent solution, or the chemical addition composition of the invention, can be added into or include component(s) of the flow system. Again, it can be advantageous to include dispersants to promote dispersion in flow component(s) that are hydrocarbon or otherwise hydrophobic based.

An enhanced flow system is created when the flow component(s) is combined with an amount of the phosphorus-containing parent solution or the chemical addition compositions sufficient to increase efficiency upon operation of the flow system. In certain circumstances, the dispersion fluid is a quantity of a target fluid, that is, a fluid that contains the component(s) of the flow system.

Compositions of phosphoric acid, alkali metal hydroxide and a source of reactive NH₂ groups has been explored in U.S. Pat. No. 5,540,788 for the creation of a conversion surface, the disclosure of the patent being incorporated herein by reference. The current invention includes the use of the conversion surface compositions as a flow enhancement composition. In one embodiment the flow enhancement composition is a chemical addition compositions for the enhancement flow systems where the chemical addition composition has the compositions disclosed in U.S. Pat. No. 5,540,788. This embodiment is unique in the use of the source of reactive NH₂ groups, which can be advantageous under certain circumstances. While the chemical compositions including reactive NH₂ groups has certain advantages, it can result in the presence of free ammonia. Various other embodiments of the flow enhancement composition of this invention avoid the production of free ammonia and the related issues.

### DETAILED DESCRIPTION

The flow enhancement composition of the invention is believed to function through a nano-mechanism to either reduce drag, or prevent the formation of an insulating surface layer or a combination of both. Preferably, the flow enhancement composition is provided as dispersion in the dispersion fluid. Preparation preferably includes forming the aqueous parent solution that is emulsified and then added into base oils. Dispersion can be aided through the use of emulsifiers and dispersants. In a preferred embodiment, a dispersant with a total base number of from 30 to 160 on an oil-free basis is used.

The aqueous parent solution can be used in concentrations of 1-150 ppm P in aqueous flow component(s) flowing in metallic pipes, tubes or other conduits. Dispersion in a dispersion fluid is not necessary. Lower concentrations are also applicable.

The invention includes the use of the flow enhancement composition in oil and gas transmission lines, industrial hydraulic systems, aircraft hydraulic systems, on- and off-road vehicle braking and power steering systems, industrial refrigeration systems, air conditioning systems, gas compression, air compression and in any flow system that consumes energy due to fluid drag or non-slip fluid layers on pipe or tube walls or any combination of energy consuming mechanisms. The term fluid can include gaseous or non-gaseous component(s).

One example of a preferred formulation of the invention includes the following ratios: 1.597 mols KH₂PO₄, 0.693 mol K₂HPO₄, 0.315 mol [NH₄]₂HPO₄ and water. The pH of the solution can be controlled through manipulation of the ratios of these components. By manipulating the ratios of the resulting H₂PO₄⁻ and HPO₄²⁻ ions, the solution can be created in a preferred pH range of about 6.0 to about 8.0.

In a preferred embodiment, KH₂PO₄, K₂HPO₄, [NH₄]₂HPO₄ and water are created into the phosphorus containing parent solution that is added to a dispersion fluid, such as a refined oil dispersion fluid, and mixed with dispersants. Exemplary dispersants include polyalkenyl succinimides such as, Oronite ODA 78012 and Ethyl Hitec 646. It may also be advantageous to include certain carrier fluids. Exemplary carrier fluids include polyoxpropylene monols, diols and polyols, polyoxybutylene monols, diols and polyols, particularly Bayer Actaclear ND17. The phosphorus containing parent solution is added in at approximately 5-10 wt. % of the refined oil dispersion fluid. This is heated to drive off a significant amount of the solvent, in this case, water. The mixture can be described at this point as a dispersion or micro-dispersion. When the resulting solution is mixed into the flow component(s), an effective amount of the phosphorus in the solution can be dilute. One example of a preferred embodiment is 0.3 wt % phosphorus in the solution. Upon addition to the flow system component(s), the phosphorus content can be in the range of 5-100 ppb and still be effective. Preferably, 1-250 ppm phosphorus is used in the flow system component(s). Higher amounts are also effective. More preferably, 1-150 ppm phosphorus by weight is in the flow system component(s).

An example of an alternate embodiment of the phosphorus-containing parent solution that is for use as a flow enhancement composition includes mixing about 2.6 molar (M) orthophosphate with alkali metal and ammonium cations, the resulting aqueous parent solution having a pH of 7 at ambient temperatures. A measured volume of this aqueous parent solution is suspended in a mixture of refined oil dispersion fluid and dispersant, most of the water of the aqueous parent solution is removed thermally, and diluted to about 0.3 weight % P. This mixture is used, with further dilution, as a flow enhancement composition. The dilution is preferably achieved with the same refined oil dispersion fluid. Group II base oil is preferred. Other preferred dispersion fluids include light hydrocarbons, gasoline, polygas, kerosene, diesel, naphtha light oils, Group I, III, IV, V or VI base oils as defined by API, aromatic oils, polybutenes, polyglycols, heavier oils or combinations of the same. An example of an alternate embodiment includes the use of phosphoric acid, potassium hydroxide, ammonium hydroxide in water. Acetic acid can also be added. The amounts of the component can be adjusted to reach the desired pH.

### EXAMPLE 1

1. Prepare a Phosphoric Acid/Acetic Acid solution [H₃PO₄/HOA_{c} Solution]. For this run, the H₃PO₄/HOA_{c} Solution is about 90% mole of H₃PO₄ and 10% mole of HOA_{c}.
2. Prepare for reaction De-ionized water
3. 2,736.39 lbs of the Potassium Hydroxide is added to the water
4. Add to this aqueous solution 1315.14 lbs of the Ammonium Hydroxide (29%)
5. Into the resulting solution, add the H₃PO₄/HOA_{c} Solution and allow for reaction.
6. After reaction, adjust pH with acetic acid to a pH of about 7.0. The resulting product of this reaction is useful as the chemical addition component to enhance flow.

### EXAMPLE 2

A flow enhancement composition was prepared by dispersion of resulting KH₂PO₄, K₂HPO₄, [NH₄]₂HPO₄ mixture from Example 1 was dispersed in a refined mineral oil. The solvent is removed from the solution in order to create the flow enhancement composition. In this case, the solvent is water and dehydration is accomplished thermally. The dispersion is further diluted in base oil to adjust to desired concentration of phosphorus in flow enhancement composition.

An alternate embodiment includes the use of [NH₄]H₂PO₄, [NH₄]₂HPO₄ and water.

In a preferred embodiment, the solvent is one that is defined by solubility or dispersability of the salts in the solvent as well as the volatility of the solvent. For example, the salts are preferably dispersed throughout the solvent but the solvent is of such volatility that it can be boiled out of solution and preferably recovered for reuse without affecting the resulting product.

Group IA metals are also preferred cations. Factors related to selection of the cation include commercial expense and corrosion resistance.

### EXAMPLE 3

Use of the flow enhancement composition described in Example 2, at a P concentration of 250 ppm, in a residential air conditioning system showed a temperature drop on the liquid line of over 50%, approximately 5% reduction in the total amperage and a better temperature split across the coil. The flow enhancement composition was added to the refrigerant side of the system at an amount of 1 ounce per 3 tons of cooling capacity.

While the invention has been shown or described in only some of its forms, it should be apparent to those skilled in the art that it is not so limited, but is susceptible to various changes without departing from the scope of the invention. For example, introduction of the salts into the flow component(s) or the dispersion fluid can be accomplished through high speed shear mixing without the creation of an intermediate solution and the subsequent thermal removal of the solvent. Regarding the salts, [Y]ₓH₂PO₄, [Y]ₓ₊₁HPO₄ also encompasses [Y]ₓ[H₂PO₄]_{z}, [Y]ₓ₊₁[HPO⁴]_{z} where x and z are variable integers.

We claim:

1. A process for enhancement of flow of a target fluid in a fluid system comprising adding an effective amount of a flow enhancement composition to the target fluid for circulation in the fluid system, the fluid enhancement composition comprising a mixture of salts and a target fluid, the salts comprising [Y]ₓH₂PO₄ and [Y]ₓ₊₁HPO₄, where [Y] is a cation and x is an integer, such that the target fluid with the salts is operable to create enhanced flow or enhanced transfer rate in the target fluid.

2. The process of claim 1 wherein the salts are non acidic.

3. The process of claim 1 wherein [Y] is a sodium cation.

4. The process of claim 1 wherein [Y] is a potassium cation.

5. The process of claim 1 wherein substantially no free ammonia, halogens or added polymers are present.

6. The process of claim 1 wherein the flow enhancement composition further comprises [NH₄]₂HPO₄.

7. The process of claim 1 for enhancing fluid flow wherein the flow enhancement composition further comprises NH₄C₂H₃O₂ where C₂H₃O₂ is an acetate group.

8. The process of claim 1 wherein the target fluid is a lubricant for circulation within a lubricant-dependant system.

9. The process of claim 8 wherein the lubricant-dependant system is selected from the group comprising a mechanical device, a refrigeration system, a motor oil system, an engine, an engine part, a gear, a drilling operation and a reciprocating combustion engine

10. A process of claim 1 wherein the target fluid is a heat transfer fluid for circulation within a heat transfer system.

11. The process of claim 10 wherein the heat transfer system is selected from the group comprising a coolant system, a hydraulic braking system, a hydraulic transmission system, a refrigeration system and an air-conditioning system.

12. The process of claim 1 wherein the target fluid is a hydro-mechanical fluid for inclusion in a mechanical system.

13. The process of claim 12 wherein the hydro-mechanical fluid is selected from the group consisting of radiator fluid, drilling fluid, engine fluid, anti-corrosive fluid, transmission fluid, hydraulic fluid, brake fluid, dielectric fluid, heat transfer fluid and cutting fluid.

14. A process for enhancement of flow of a target fluid in a fluid system comprising adding an effective amount of a flow enhancement composition to the target fluid for circulation in the fluid system, the fluid enhancement composition comprising a mixture of salt and a target fluid, the salt comprising [Y]ₐB_{b}O_{c}, wherein [Y] is a cation and a, b and c are variable integers, such that the target fluid with the salt is operable to create enhance flow or enhanced transfer rate in the target fluid.

15. The process of claim 14 wherein the salt is non acidic.

16. The process of claim 14 wherein the salt is selected from the group consisting of metaborate, pentaborate, tetraborate and orthoborate and combinations thereof.

17. The process of claim 14 further comprising [NH₄]₂B₄O₇.

18. The process of claim 14 wherein the pH of the solution containing the target fluid with the salt is between about 6.0 and 8.0.

19. The process of claim 14 wherein the salt is inorganic.

20. The process of claim 14 wherein the target fluid is a lubricant for circulation within a lubricant-dependant system.

21. The process of claim 20 wherein the lubricant-dependant system is selected from the group comprising a mechanical device, a refrigeration system, a motor oil system, an engine, an engine part, a gear, a drilling operation and a reciprocating combustion engine

22. A process of claim 14 wherein the target fluid is a heat transfer fluid for circulation within a heat transfer system.

23. The process of claim 22 wherein the heat transfer system is selected from the group comprising a coolant system, a hydraulic braking system, a hydraulic transmission system, a refrigeration system and an air-conditioning system.

24. The process of claim 14 wherein the target fluid is a hydro-mechanical fluid for inclusion in a mechanical system.

25. The process of claim 24 wherein the hydro-mechanical fluid is selected from the group consisting of radiator fluid, drilling fluid, engine fluid, anti-corrosive fluid, transmission fluid, hydraulic fluid, brake fluid, dielectric fluid, heat transfer fluid and cutting fluid.

26. A process for enhancing flow of a target fluid in a fluid system comprising the step of adding an amount effective to enhance flow of the target fluid in the fluid system of a chemical addition composition, the chemical addition composition comprising reaction products from mixing of a source of phosphoric acid, an alkali metal hydroxide, ammonium hydroxide and water.
